(19) United States
(12) Patent Application Publication
(10) Pub. No.: US 2026/0211421 A1
(43) Pub. Date: Jul. 23, 2026

(54) MOBILE ROBOT

(71) Applicant: THK CO., LTD., Tokyo (JP)

(72) Inventors: Kaoru Hoshide, Minato-ku, Tokyo (JP); Jun Kawasaki, Minato-ku, Tokyo (JP); Masaki Shibuya, Minato-ku, Tokyo (JP); Norimasa Okada, Minato-ku, Tokyo (JP)

(73) Assignee: THK CO., LTD., Tokyo (JP)

(21) Appl. No.: 19/143,037

(22) PCT Filed: Dec. 22, 2023
(86) PCT No.: PCT/JP2023/046088

§ 371 Date: Jun. 25, 2025

(30) Foreign Application Priority Data
Dec. 26, 2022 (JP) 2022-208603

(51) Int. Cl. G05D 1/49; B64U 10/13; B64U 60/50; G05D 109/25

(52) U.S. Cl. CPC G05D 1/498; B64U 10/13; B64U 60/50; G05D 2109/254

(57) ABSTRACT

A mobile robot includes a main body portion having a plurality of propulsion units configured to generate propulsion forces by driving rotary wings, and a plurality of support portions provided on the main body portion and configured to come into contact with a predetermined contact surface to be capable of supporting at least a part of the main body portion, wherein when movement control is performed while supporting the main body portion by the plurality of support portions, in assist control for the movement control, a part or all of the plurality of propulsion units are driven to generate an assistive support force in the outside of an actual support region, in a case where a target pressure position related to the transition of a center of gravity of the main body portion in the movement control is not inside the actual support region in which the main body portion is actually supported by predetermined support portions in contact with the predetermined contact surface among the plurality of support portions.

### TECHNICAL FIELD

This invention relates to a mobile robot that is capable of flight and movement operation.

### BACKGROUND ART

In recent years, unmanned aerial vehicles have been used for various purposes, and their development has been actively pursued. As the unmanned aerial vehicles, there are used radio-controlled unmanned helicopters or so-called drones. For example, examples of the use of drones for agricultural purposes include spraying agricultural chemicals, observing the growth of crops using onboard cameras, and generating air currents to protect crops from frost damage (see, for example, Patent Literature 1). Further, robots capable of flight with arms or the like for performing a predetermined work installed on unmanned aerial vehicles has been developed so that the robots can be widely used not only for agricultural purposes but also for other purposes (for example, see Patent Literature 2).

In addition, Patent Literature 3 discloses a mobile robot that performs a flight motion by propulsion units and a walking motion while being placed on the ground. In the mobile robot, walking is performed by two leg portions, and when a tilt or inclination of a main body portion of the robot is increased by a sensor during its walking motion, the posture of the robot is controlled by using the propulsion units so that the inclination falls within a predetermined angle range.

### CITATION LIST

### Patent Literature

Patent Literature 1: Japanese Patent Application Laid-Open Publication No. 2018-000015
Patent Literature 2: WO 2016/193666
Patent Literature 3: Japanese Patent No. 6733965

### SUMMARY OF INVENTION

### Technical Problem

In a case where the main body portion of the robot is moved in a state in which the robot is in contact with a contact surface such as the ground, i.e., in a case where the movement of the robot accompanied by contact with the contact surface such as walking is performed instead of its movement by flight (in the present application, the former form of movement is referred to as “flight movement” and the latter form of movement is referred to as “contact movement”), the main body portion of the robot needs to realize its movement while being supported by support portions (e.g., leg portions) in contact with the contact surface so as to prevent the main body portion from tipping over. In general, in the contact movement, when the speed of the movement is rapid, it becomes difficult to maintain the stability of the robot main body, thus increasing the possibility of tipping over. In addition, the main body portion of the robot will swing as it moves, which inhibits the acquisition of information about the position and posture of the robot, which is required for stable contact movement of the robot, thus resulting in that the possibility of the robot main body portion tipping over cannot be eliminated.

The present invention has been made in view of the above-mentioned problems, and an object of the present invention is to provide a robot technology in which, in a robot that moves in contact with a contact surface, stable contact movement is realized by avoiding a main body portion of the robot from tipping over as much as possible.

### Solution to Problem

In the present invention, in order to solve the above-mentioned problems, a configuration is adopted in which a robot according to the present invention is provided with support portions that come into contact with a contact surface, and the propulsion forces of propulsion units are controlled. In addition to this, the robot is provided with a first controller for contact movement when the contact movement is performed using the support portions, and a second controller configured to perform assist control for assisting the contact movement using the propulsion units. With such a configuration, it is possible to realize stable contact movement in the robot.

In detail, a mobile robot according to the present invention includes: a main body portion having a plurality of propulsion units configured to generate propulsion forces by driving of rotary wings; a plurality of support portions provided on the main body portion and configured to come into contact with a predetermined contact surface to be capable of supporting at least a part of the main body portion; a first controller configure to perform movement control in which the main body portion moves on the predetermined contact surface by the plurality of support portions while supporting the main body portion by the plurality of support portions; and a second controller configured to perform assist control for the movement control by the first controller using a part or all of the plurality of propulsion units. Then, in the assist control, when a target pressure position related to the transition of a center of gravity of the main body portion in the movement control is not inside the actual support region in which the main body portion is actually supported by predetermined support portions that are in contact with the predetermined contact surface among the plurality of support portions, the second controller drives a part or all of the plurality of propulsion units to generate in the outside of the actual support region an assistive support force that assists a shortage of a support force required for the movement control.

### Advantageous Effects of Invention

In the mobile robot that moves in contact with the contact surface, it is possible to avoid the main body portion from tipping over as much as possible thereby to realize stable contact movement.

### BRIEF DESCRIPTION OF DRAWINGS

FIG. 1 is a view illustrating a schematic configuration of a mobile robot according to an embodiment.

FIG. 2 is a functional block diagram illustrating an image of functional units formed in the mobile robot according to the embodiment.

FIG. 3 is first views for explaining assist control for assisting walking of the mobile robot.

FIG. 4 is a second view for explaining assist control for assisting walking of the mobile robot.

FIG. 5 is a third view for explaining assist control for assisting walking of the mobile robot.

FIG. 6 is a fourth view for explaining assist control for assisting walking of the mobile robot.

FIG. 7 is a fifth diagram for explaining assist control for assisting walking of the mobile robot.

FIG. 8 is diagrams illustrating the transitions of a posture variation of the mobile robot corresponding to the presence and the absence of assist control in the mobile robot.

FIG. 9 is sixth views illustrating assist control for walking of the mobile robot.

FIG. 10 is views illustrating a first form in which assist control for walking of the mobile robot is performed.

FIG. 11 is views illustrating a second form in which assist control for walking of the mobile robot is performed.

### DESCRIPTION OF EMBODIMENTS

A mobile robot of the present embodiment can generate a propulsion force for raising or lowering a main body portion thereof by means of a plurality of propulsion units provided at a main body portion side. Each of the propulsion units has a rotary wing, and a propulsion force generated by each propulsion unit is determined by rotationally driving the corresponding rotary wing. Preferably, the propulsion forces of the respective propulsion units can be controlled independently. The arrangement of the plurality of propulsion units on the main body portion can be designed in an optional manner. The mobile robot may be configured to be capable of flying (ascending, descending, turning, etc.) by balancing the propulsion forces of the respective propulsion units provided on the main body portion.

The plurality of propulsion units provided on the main body portion may all be of the same type or may be a mixture of different types.

Then, the mobile robot is equipped with a plurality of support portions, so that its main body portion is supported against a predetermined contact surface. Note that the support of the main body portion by the support portions may be in the vertical direction, or may be in a direction other than the vertical direction. In the former case, the support portions may be configured as leg portions that come into contact with the contact surface to allow the main body portion to walk thereon. In the latter case, the support portions can be configured as arm portions that serve to enable the main body portion to be moved in contact with the contact surface while gripping. As the configurations of the support portions, other ones than these configurations described above can also be adopted.

Here, in the mobile robot, the first controller controls to execute contact movement in which the mobile robot moves on the contact surface using the plurality of support portions. The first controller controls the driving of the plurality of support portions to prevent the main body portion from coming into contact with the contact surface due to tipping over, i.e., to perform contact movement while maintaining support by the support portions. Here, when the control by the first controller is being performed, the contact between a part of the plurality of support portions and the contact surface may be momentarily or temporarily eliminated, so that the stability of the support of the main body portion by the plurality of support portions may be reduced. Such a reduction in stability does not necessarily result in the mobile robot toppling over, but it is preferable that the degree of the reduction be as small as possible. In particular, if it is difficult to predict the condition of the contact surface with which the support portions come into contact, the possibility of tipping over is increased due to the inability of the first controller to provide good control of the movement.

Therefore, when the possibility of such tipping over increases, assist control for movement control is performed by a second controller. In the assist control, when a target pressure position is not inside an actual support region, it is considered that a support force by the support portions required for stable contact movement is insufficient, thus increasing the possibility of tipping over. The target pressure position is a position of a zero moment point (ZMP) of the mobile robot, which is assumed when the first controller performs the contact movement. The actual support region is a region on the contact surface, which is defined by the contact parts of those support portions which are in contact with the contact surface among the plurality of support portions. As described above, when the possibility of tipping over is assumed to be high from a correlation between the target pressure position and the actual support region, the propulsion forces generated by driving a part or all of the plurality of propulsion units are used to generate an assistive support force in the outside of the actual support region thereby to assist a shortage of the support force.

In this manner, when it is determined that the possibility of tipping over is high, the propulsion forces of the propulsion units are used to assist the shortage of the support force by the plurality of support portions, and hence it is possible to accurately provide the assistive support force for preventing the mobile robot from tipping over, regardless of the movement or the posture and position of the support portions. This simplifies the configuration for preventing tipping over in the mobile robot, and hence, for example, the arrangement of sensors or the like for smooth contact movement can be omitted. Further, even if the state of the contact surface is not as expected, the assistive support force can be accurately generated by suitably driving the propulsion units, thus making it possible to realize stable contact movement.

Hereinafter, specific embodiments of the present Invention will be described based on the accompanying drawings. The dimensions, materials, shapes, numbers, relative arrangements, and the like of component parts described in the embodiments are not intended to limit the technical scope of the present invention to only those unless otherwise described.

### Embodiment

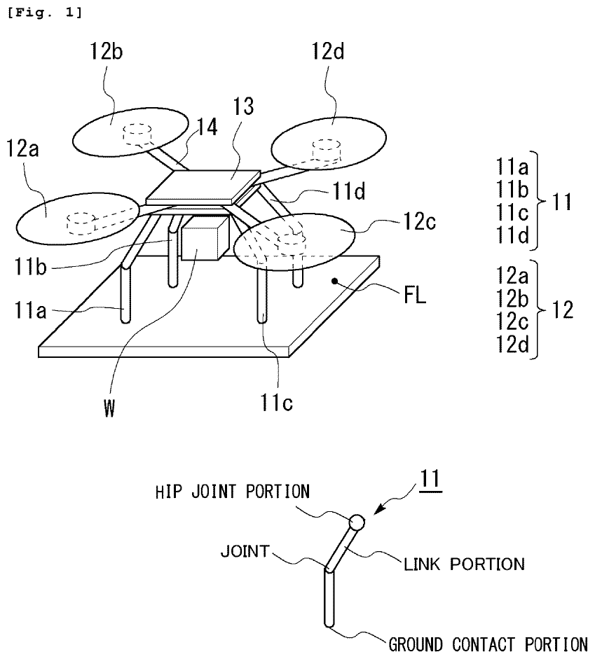

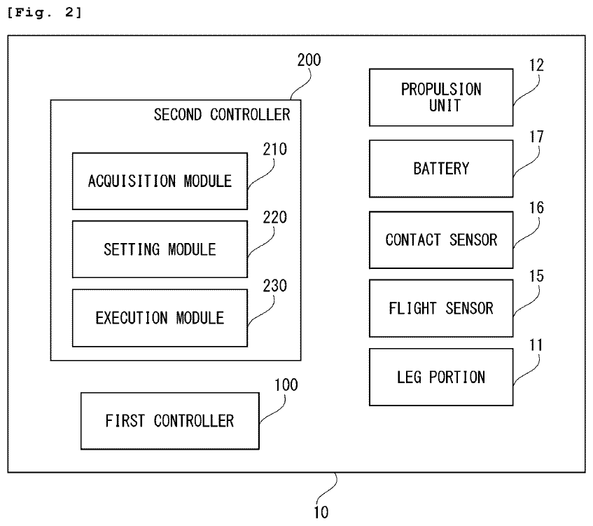

Here, an outline of a mobile robot 10 according to the present embodiment will be described based on FIGS. 1 and 2. FIG. 1 is a view illustrating an external appearance configuration of the mobile robot 10, and FIG. 2 is a diagram illustrating functional blocks included in the mobile robot 10. A main body portion 13 of the mobile robot 10 includes a portion mainly related to a flight motion of the mobile robot 10, and a portion mainly related to a walking motion of the mobile robot 10. That is, in the present embodiment, the mobile robot 10 is configured to be capable of realizing the flight motion and the walking motion.

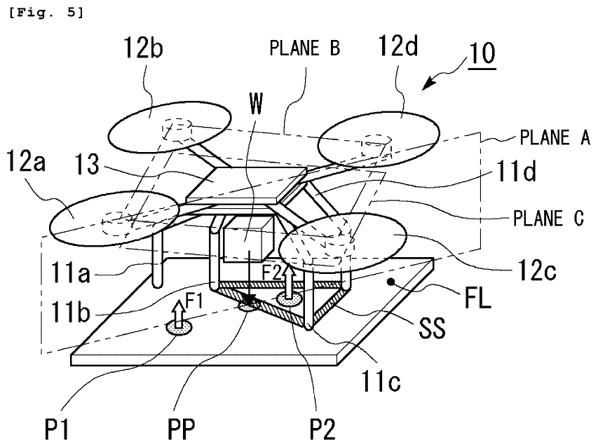

First, a structure related to a flight motion will be described. A plurality of propulsion units 12 are arranged on the main body portion 13 via a plurality of bridge members. In the example illustrated in FIG. 1, four propulsion units 12 are mounted on the main body portion 13, but as long as the flight of the mobile robot 10 is possible, the number of propulsion units 12 mounted thereon is not limited to four as long as it is plural. Further, in the present embodiment, when the mobile robot 10 is in a reference posture with respect to the contact surface (e.g., the ground or the like) FL, a rotor plane (see plane B of FIG. 5 to be described later), which is formed by connecting the center points of the four propulsion units, is parallel to the contact surface FL, and the four propulsion units 12 are respectively arranged in rotational symmetry around the main body portion 13 on the plane B. In other words, the four propulsion units 12 are arranged on the plane B in line symmetry with respect to a predetermined center line or in point symmetry with respect to a predetermined point. Here, note that in the reference posture, all of the four leg portions 11 to be described later are in a predetermined state so that the main body portion 13 is not inclined with respect to the contact surface FL. Note also that when the propulsion units 12 are individually referred to, reference signs 12a through 12d are used.

The propulsion units 12 each include a propeller, which is a rotary wing, and an actuator for rotationally driving the propeller. All the four propulsion units 12 are of the same type, but the actuators in the respective propulsion units 12 can be controlled independently. Therefore, it is possible to appropriately control the propulsion force obtained by each propulsion unit 12, and thus it becomes possible to appropriately control the flight posture, the flight speed, and the like of the mobile robot 10. Further, as will be described later, in the assist control when the mobile robot 10 is performing a walking motion, too, the actuators can be independently controlled in the respective propulsion units 12. In addition, the mobile robot 10 is equipped with a sensor (flight sensor) 15 necessary for its flight motion, sensors (contact sensors) 16 necessary for its walking motion, a battery 17 (see FIG. 2) for supplying drive power to the sensors and the actuator of each propulsion unit 12, and a control device for controlling the power supply from the battery 17 to each actuator. In the control device, two controllers, a first controller 100 and a second controller 200, are incorporated, and details thereof will be described later.

Next, a structure related to the walking motion will be described. The mobile robot 10 has leg portions 11 (four legs) configured to be capable of executing the walking motion. Note that in the example illustrated in FIG. 1, four leg portions 11 are provided on the main body portion 13, but the number of the leg portions 11 is not limited to four as long as the walking motion is possible, and two or three leg portions 11 may be provided, or five or more leg portions 11 may be provided. Note that in a case where the leg portions 11 are individually referred to, reference signs 11a through 11d are used.

As an example of the leg portions 11, a simple view of each leg portion 11 is illustrated in FIG. 1. The leg portions 11 each have a ground contact portion that comes in contact with the ground when the mobile robot 10 walks by walking motion, a link portion that is relatively rotatably connected to the ground contact portion via a joint, a hip joint portion that is relatively rotatably connected to the link portion via a joint, and a plurality of actuators (not illustrated) that drive and control the rotation of each joint. The joint related to the link portion is designed for its rotational directions (i.e., rotational directions around a roll axis and a pitch axis) according to the walking motion to be assumed. Note that the configuration of each leg portion 11 is not limited to such an example. In addition, each hip joint portion is connected to a lower side of the main body portion 13 via a predetermined joint so as to be relatively rotatable. This predetermined joint is configured to be rotatable about a yaw axis. The predetermined joint may also be configured to be rotatable about a roll axis and a pitch axis.

The leg portions 11 configured as described above are a structure that enables the walking motion of the mobile robot 10 while supporting the self-weight of the mobile robot against the contact surface FL in the walking motion of the mobile robot 10. Therefore, the four leg portions 11 function as the support portions of the present invention for realizing the walking motion included in the type of the movement motion. In addition, unlike the flight motion, the movement of the mobile robot is performed in a state in which at least one of the four leg portions 11 is in contact with the contact surface FL to support the main body portion 13. Therefore, the walking motion is also one form of motion included in the contact movement.

### <Control Unit of Mobile Robot 10>

Next, the control configuration of the mobile robot 10 will be described based on FIG. 2. The mobile robot 10 has a control device including a first controller 100 and a second controller 200. The control device is a computer including an arithmetic processing device and a memory, and the second controller 200 includes, as functional units, an acquisition module 210, a setting module 220, and an execution module 230. Each functional unit is formed by executing a predetermined control program in the mobile robot 10.

First, the first controller 100 will be described. The first controller 100 is a functional unit for performing a walking motion and a flight motion in the mobile robot 10 using the leg portions 11 and the propulsion units 12. That is, the first controller 100 controls the actuators provided on the leg portions 11 for the walking motion, and further controls the propulsion units 12 for the flight motion. The first controller 100 controls the propulsion forces of the four propulsion units 12 based on environmental information, which is information related to the flight state of the mobile robot 10 and is detected by the flight sensor 15. As such environmental information, there can be exemplified information about an angular velocity of the main body portion 13 detected by a gyro sensor corresponding to unillustrated three axes (a yaw axis, a pitch axis, and a roll axis), a tilt or inclination of the main body portion 13 detected by an acceleration sensor corresponding to the same unillustrated three axes, and the like. The first controller 100 performs feedback control using the environmental information acquired from these sensors so that the tilt of the main body portion 13 of the mobile robot 10 is in a state suitable for flight. Further, the environmental information may include an azimuth angle which is the orientation of the main body portion 13 (i.e., the orientation of the main body portion of the mobile robot 10) in the absolute coordinate system when the orientation of the earth's axis is set as a reference, and the azimuth angle can be detected by an azimuth angle sensor.

Here, in a case where the main body portion 13 of the mobile robot 10 is caused to fly forward, backward, leftward, and rightward, the first controller 100 decreases the number of revolutions of the actuator of a propulsion unit 12 in the direction of travel and increases the number of revolutions of the actuator of a propulsion unit 12 on the side opposite to the direction of travel, so that the main body portion of the mobile robot 10 takes a forward-leaning posture with respect to the direction of travel, thus traveling in a desired direction. Also, in a case where the main body portion of the mobile robot 10 is caused to rotate and fly, the first controller 100 provides the output of each propeller 21 according to the direction of rotation thereof based on the direction of rotation of the main body portion 13 of the mobile robot 10. For example, when turning the main body portion 13 of the mobile robot 10 to the right, the first controller 100 decreases the output of the actuator corresponding to the propeller that is rotating to the right, and increases the output of the actuator corresponding to the propeller that is rotating to the left.

Further, a walking motion performed by the first controller 100 will be described. The first controller 100 is also a functional unit that, when the mobile robot 10 walks, controls an actuator provided on each of the four leg portions 11 for the walking. The first controller 100 uses environmental information, detected by the contact sensors 16, that indicates whether or not the ground contact portion of each leg portion 11 is in contact with the contact surface FL, when the walking motion is performed. Note that, in the present embodiment, a predetermined walking control program for walking on the contact surface FL, which is used by the first controller 100, utilizes detection values of the contact sensors 16 by reducing the acquisition of information about the surrounding environment of the mobile robot 10 as much as possible in order to make the walking control of the mobile robot 10 simpler and easier.

More specifically, the actuator provided on each joint of the leg portions 11 is provided with an encoder (not illustrated) that detects state quantities (the rotation position, the rotation speed, and the like of the rotation shaft of the actuator) related to each rotation state. Note that a sensor other than the encoder may be used. Then, the first controller 100 performs feedback control on the actuators of the leg portions 11 based on the state quantities of each actuator detected by the encoder of the actuator so that the walking motion of the mobile robot 10 is realized in accordance with a movement instruction provided to the mobile robot 10. As described above, in the present embodiment, the feedback control of the actuators makes as little use of environmental information outside the robot as possible. This makes it possible to omit the sensors to be mounted on the mobile robot 10 as much as possible and to simplify the walking control itself.

Further, during the walking control, the contact sensors 16 detect whether or not the ground contact portions of the respective leg portions 11 are in contact with the contact surface FL. The fact that a leg portion 11 is not in contact with the contact surface FL means that the main body portion 13 of the mobile robot 10 is not supported by a reaction force from the contact surface FL via that leg portion 11. Thus, if the main body portion 13 of the mobile robot 10 is not supported by the leg portion 11, the stability of the main body portion 13 can change, and in some cases, the possibility of the main body portion 13 tipping over increases. In such a case, in the present embodiment, the assist control by the second controller 200 (corresponding to “assist control for walking control” according to the present invention) is performed.

### <Assist Control>

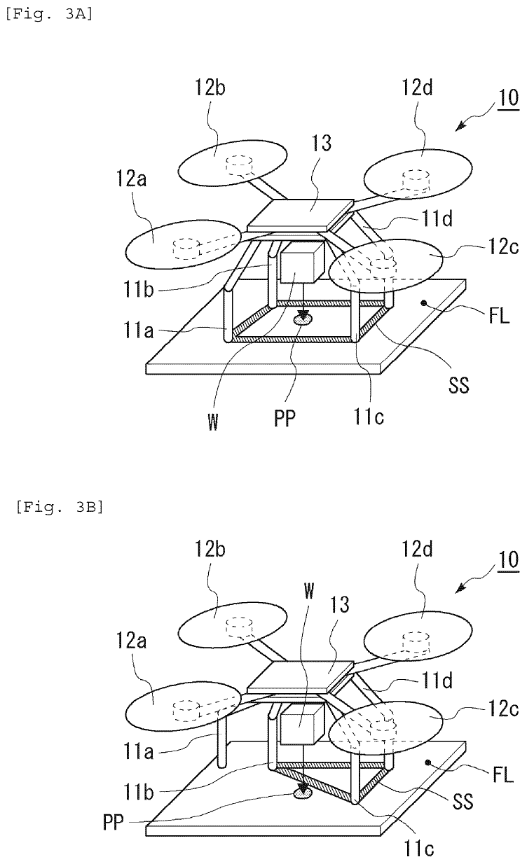

Hereinafter, the assist control by the second controller 200 will be described. The second controller 200 has the acquisition module 210, the setting module 220, and the execution module 230, and these functional units cooperate with one another to realize the assist control. Here, a change in the stability of the main body portion 13 during the walking control (when the mobile robot 10 is performing the walking motion) will be described based on FIG. 3. The upper part (a) of FIG. 3 indicates a state in which the four leg portions 11 of the mobile robot 10 are in contact with the contact surface FL, and the lower part (b) thereof indicates a state in which one leg portion 11a among the four leg portions 11 is separated or away from the contact surface FL. The state in which the leg portion 11a is separated from the contact surface FL is detected by the contact sensor 16 of the leg portion 11a. Here, it is assumed that the mobile robot 10 is performing a walking motion with a workpiece W mounted thereon.

Here, for the leg portions 11 whose ground contact portions are actually in contact with the contact surface FL, a closed region, which is formed so as to include the contact points, is defined as an actual support region SS. As an example, the actual support region SS may be a polygonal region having the contact points as vertexes. In this case, in FIG. 3 (a), the actual support region SS is formed in a quadrangular shape, and in FIG. 3 (b), the actual support region SS is formed in a triangular shape. In addition, from the viewpoint of suitably supporting the mobile robot 10, the actual support region SS may be formed in shapes further reduced to the inside with respect to the forms shown in FIGS. 3 (a) and (b). Note that the second controller 200 can determine the position of the contact point of each leg portion 11 from the detection value of each contact sensor 16 and the state (position) of the actuator of each leg portion 11 when the contact state thereof is detected.

Then, in a case where the mobile robot 10 performs walking control using the four leg portions 11, a position where the center of gravity of the mobile robot 10 should be located during the walking motion is given as a position command to the first controller 100, and each leg portion 11 is driven so as to follow the position command. At this time, the position of an ideal ZMP calculated from the trajectory or the like of the mobile robot 10 is defined as a target pressure position PP. The load of the workpiece W carried by the mobile robot 10 is also taken into consideration for the target pressure position PP. Then, during the walking control, as illustrated in FIG. 3 (a), when the target pressure position PP is located inside the actual support region SS, the mobile robot 10 is stably supported by the four leg portions 11. On the other hand, as illustrated in FIG. 3 (b), when the target pressure position PP is not located inside the actual support region SS, the mobile robot 10 is not stably supported by the three leg portions 11b, 11c, 11d. Therefore, in this case, the mobile robot 10 may tip over.

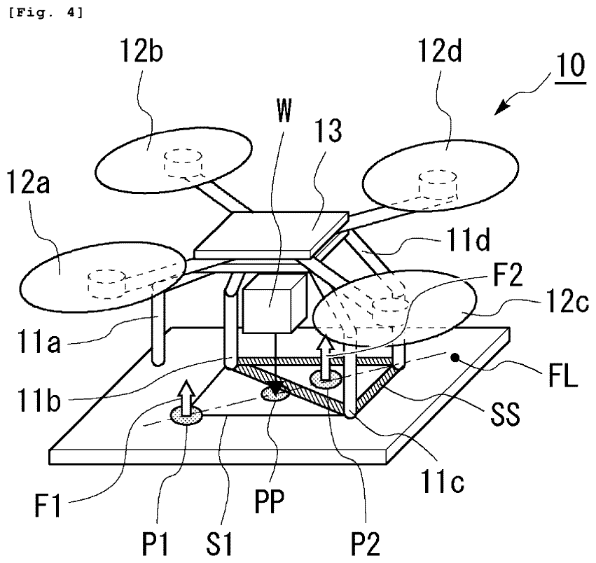

Therefore, in order to suppress tipping over that may occur due to the target pressure position PP deviating from the actual support area SS in this manner, in the present embodiment, the four propulsion units 12 are utilized to generate an additional support force (assistive support force) required to suppress the tipping over. The generation of the assistive support force will be described based on FIG. 4. The state of the mobile robot 10 illustrated in FIG. 4 is the same as that illustrated in FIG. 3 (b), and the target pressure position PP is located outside the actual support region SS. Here, upon assisting the support force, a load to be supported by the leg portions 11b, 11c, 11d in actual contact with the contact surface FL is set. This load will be a load to be supported by the leg portions 11b, 11c, 11d for the total load required for the movement of the mobile robot 10 to be supported, which should be shared by the leg portions 11b, 11c, 11d and the propulsion units 12. Therefore, the load can be appropriately set by taking into consideration the propulsion forces of the propulsion units 12 and the supporting forces of the leg portions 11 (the outputs of the actuators incorporated in the leg portions 11b, 11c, 11d, the structural strength thereof, etc.). In general, in order to allow the mobile robot 10 to stand stably on the contact surface FL, it is preferable that a certain amount of load be applied through the leg portions 11b, 11c, 11d to generate an appropriate frictional force, and hence it is not preferable to unnecessarily reduce the load to be supported by the leg portions 11b, 11c, 11d. Then, the location where a resultant force F2 of the loads by the leg portions 11b, 11c, 11d is generated is defined as a support generation position P2. The support generation position P2 is determined to be an optional position within the actual support region SS of the leg portions 11b, 11c, 11d.

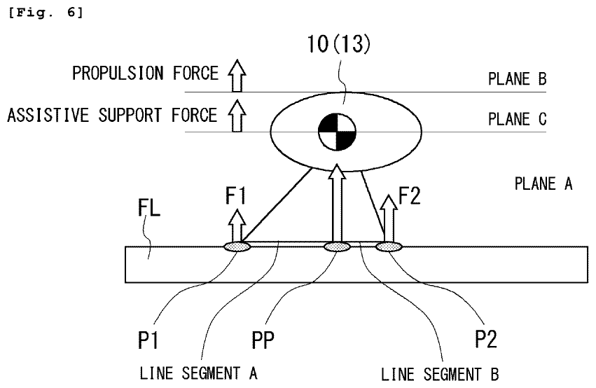

Then, an assistive support force F1 is generated at the virtual support position P1 that is outside the actual support region SS. The virtual support position P1 is a position in a region corresponding to an actual support region that will be formed if the support force is generated at the virtual support position P1 by the leg portions 11, i.e., a position in an enlarged support region S1 inside which the target pressure position PP is included when the enlarged support region S1 is formed by the contact points of the leg portions 11b, 11c, 11d and the virtual support position P1. The identification of the virtual support position P1 and the calculation of the assistive support force F1 will be described based on FIG. 5 and FIG. 6. The state of the mobile robot 10 in FIG. 5 is the same as that illustrated in FIG. 4.

In FIG. 5, three planes A through C are set for the purpose of explanation. The plane A is a plane that includes the target pressure position PP and the support generation position P2 and extends in the vertical direction (the direction perpendicular to the contact surface FL). The plane B is a plane that includes the centers of the four propulsion units 12 and is parallel to the contact surface FL. The plane C is a plane that includes the center of gravity of the mobile robot 10 and is parallel to the contact surface FL. As can be seen from FIG. 6, the propulsion forces by the propulsion units 12 act on the plane B. The propulsion forces generate the assistive support force F1 to support the load required for the movement of the mobile robot 10 associated with the walking motion. At this time, the plane B formed by the propulsion units 12 will be supported so as to be parallel to the contact surface FL.

Here, the virtual support position P1 at which the assistive support force F1 is generated is located on a straight line connecting the support generation position P2, at which the resultant force F2 of the loads by the leg portions 11b, 11c, 11d is generated, and the target pressure position PP. The reason for arranging the three points on a straight line in this manner is that the mobile robot 10 is less likely to lose balance when the support force is assisted by the propulsion units 12. Therefore, as long as the balance of the mobile robot 10 is kept within an allowable range, the three points do not necessarily have to be arranged on a straight line. Note that in the present embodiment, the three points are arranged on a straight line, and a line segment between the virtual support position P1 and the target pressure position PP is defined as line segment A, and a line segment between the support generation position P2 and the target pressure position PP is defined as line segment B. In such a case, F1 can be calculated according to the following Formula 1.

$$F 1 : F 2 = the legnth of line segment B : the length of line segment A \qquad ( Formula 1 )$$

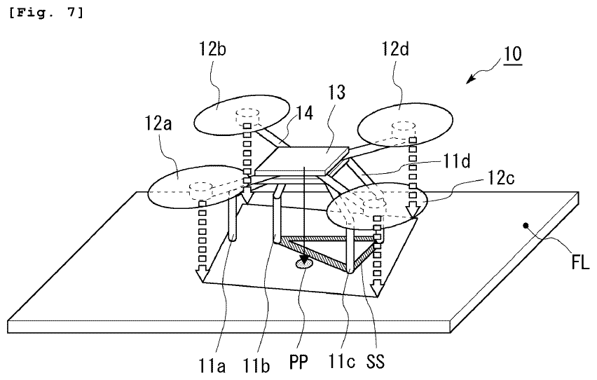

From Formula 1, as the length of line segment A is set longer, the support of the mobile robot 10 can be assisted while reducing the assistive support force. Therefore, in order to reduce the outputs of the propulsion units 12 that generate the assistive support force, it is preferable that line segment A be set to be the longest, i.e., at the position farthest from the target pressure position. Here, as illustrated in FIG. 7, in the mobile robot 10, four propulsion units 12 are arranged from the main body portion 13 via bridge members 14. The distance from the center of point symmetry of the mobile robot 10 to each propulsion unit 12 can be suitably ensured by each bridge member 14. Since the resultant force of the propulsion forces by the propulsion units 12 is directly under each propulsion unit 12 at the position farthest from the position of the center of gravity, the arrangement of the propulsion units 12 via the bridge members as described above contributes to ensuring a longer length of line segment A in Formula 1.

Here, the assist of the support force will be discussed from a physical point of view. For simplicity of explanation, it is assumed that the airframe of the robot is in a static state and is not in contact with any object other than the contact surface FL. When considering dynamic states, it is necessary to take into account the forces required for the desired motion in addition to the gravity acting on the mobile robot 10. In addition, when the airframe is in contact with an object other than the contact surface FL, it is necessary to take its contact force into consideration. In FIG. 6, the total sum of the reaction force (resultant force F2) that is transmitted from the contact surface to the leg portions 11, and the virtual support force (assistive support force F1) that is assumed to be generated on the contact surface FL by the propulsion units 12 is equal to the gravity, and hence, the following Formula 2 holds.

$$[ Math . 1 ]$$

$${\sum }_{i = 1}^{4} {f}_{Ri} + {\sum }_{i = 1}^{n} {f}_{vi} - mg = 0 \qquad ( Formula 2 )$$

where fRi represents the reaction force transmitted to each leg portion 11, and fVi represents the above-mentioned virtual support force.

Further, the total sum of the moment due to the reaction force (resultant force F2) that is transmitted from the contact surface to the leg portions 11 in contact therewith, and the moment due to the virtual support force (assistive support force F1) that is assumed to be generated on the contact surface FL by the propulsion units 12 becomes zero, and hence, the following Formula 3 holds.

$$[ Math . 2 ]$$

$${\sum }_{í = 1}^{4} {r}_{Ri} \times {f}_{Ri} + {\sum }_{i = 1}^{n} {r}_{vi} \times {f}_{vi} = {\sum }_{i = 1}^{4} {r}_{Ri} \times {f}_{Ri} + {\sum }_{i = 1}^{4} {r}_{ri} \times {f}_{vi} = 0 \qquad ( Formula 3 )$$

where rRi represents the position of the ground contact portion of each leg portion, rVi represents the position at which the above-mentioned virtual support force is generated (virtual support position P1), and rRi represents the position of each propulsion unit 12. In addition, frVi represents the propulsion force of each propulsion unit 12 required for generating the assistive support force.

Then, the setting module 220 illustrated in FIG. 2 sets the reaction force fRi transmitted to each leg portion 11 that satisfies Formula 1, Formula 2, and Formula 3. Further, the execution module 230 calculates the assistive support force F1 that satisfies Formula 1, Formula 2, and Formula 3, and adjusts the output of each propulsion unit so as to generate the assistive support force F1 at the virtual support position P1. In addition, the acquisition module 210 acquires the target pressure position PP at the time when the walking control of the mobile robot 10 is being performed. The target pressure position PP thus acquired is used for determining whether or not it is located inside the actual support region SS, for calculation according to Equation 1, and the like, as described above.

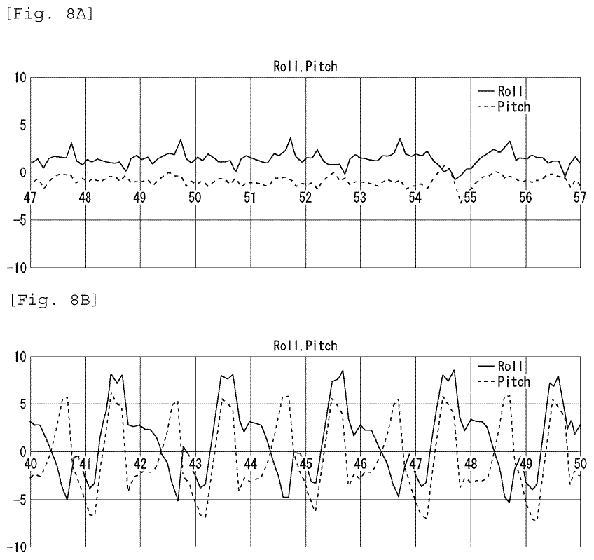

FIG. 8 illustrates the variation transitions of the inclination of the main body portion 13 of the mobile robot at the time when the mobile robot 10 actually walks, in a case where assist control is performed by the second controller 200 (upper view (a)), and in another case where assist control is not performed (lower view (b)). The roll axis and the pitch axis of the mobile robot 10 are axes included in a plane parallel to the contact surface FL. As can be seen from FIG. 8, by performing the assist control by the second controller 200, the variation in the inclination of the main body portion 13 is suppressed as compared with the case where the assist control is not performed, thus improving the stability of the walking motion of the mobile robot 10. In addition, as described above, a stable walking motion is achieved, as illustrated in FIG. 8, despite the fact that the number of sensors to be used is small because the use of environmental information is suppressed as much as possible for the walking control of the mobile robot 10.

### Modified Embodiment 1

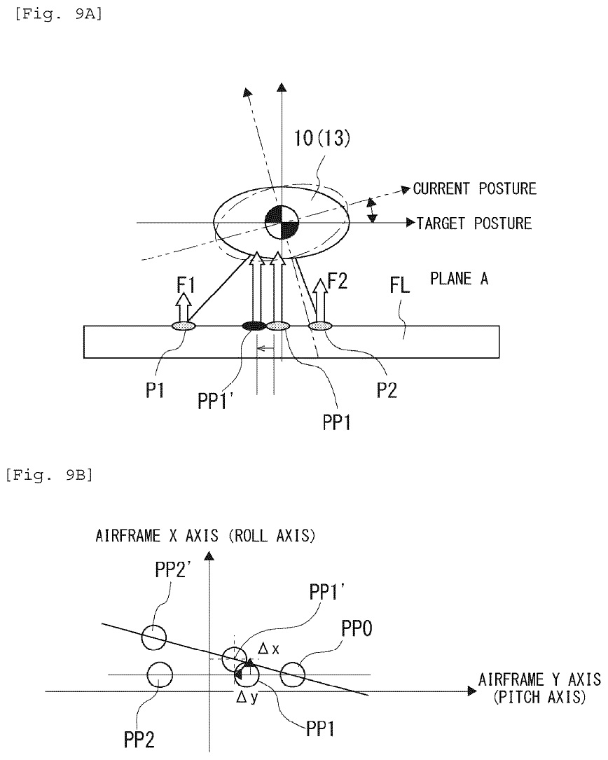

A modified example of the mobile robot 10 disclosed in the present application will be described based on FIG. 9. As described based on FIG. 6, the assistive support force F1 is a force for supporting the main body portion 13 of the mobile robot 10 in such a manner that the plane B is parallel to the contact surface FL. However, depending on the posture of the mobile robot 10, the output response of the propulsion units 12, or the like, there is a possibility that the posture of the mobile robot 10 is significantly deviated, as illustrated in the upper part (a) of FIG. 9. Therefore, in the present modified embodiment, for example, the angle and the angular velocity around the roll axis and the pitch axis of the mobile robot 10 may be fed back to correct the target pressure position PP. The angle and the angular velocity around each axis are detected by a sensor (gyro sensor or the like) capable of detecting the angle and the angular velocity.

As a result of the correction, for example, the target pressure position, which would originally shift to PP0, PP1, and PP2, shifts to PP0, PP1′, and PP2′ (see the lower part (b) of FIG. 9). In this case, the path along which the mobile robot 10 actually moves will deviate from the path along which the mobile robot 10 should originally move, but on the other hand, the posture of the mobile robot 10 is maintained in a more stable state. For this reason, the above-mentioned feedback processing can be said to be useful in a case where there is a relatively large margin in the setting of the walking path.

### Modified Embodiment 2

In the mobile robot 10, apart from the generation of the assistive support force, the outputs of the propulsion units 12 may be feedback controlled to control the posture of the main body portion 13. In this case, the propulsion units 12 output propulsion forces required for the generation of the assistive support force and the posture control in an overlapping manner, and the propulsion forces required for the posture control is referred to as posture control propulsion forces. Further, the mobile robot 10 may additionally drive the propulsion units 12 to further output the propulsion forces in order to apply a suitable load to the contact surface FL to achieve the stability of the posture during the walking motion by its frictional force, or conversely, in order to reduce the frictional force with the contact surface FL to reduce the energy required for the walking motion. The propulsion forces of the propulsion units 12 for adjusting the load on the contact surface FL are referred to as self-weight compensation propulsion forces, and the load generated on the contact surface FL by the self-weight compensation propulsion forces is referred to as a self-weight compensation target.

Therefore, the following Formula 4 holds.

$$[ Math . 3 ]$$

$${f}_{all} = {\sum }_{í = 1}^{4} {f}_{Ri} + {\sum }_{i = 1}^{n} {f}_{vi} - mg + {\sum }_{i = 1}^{4} {f}_{corri} + {\sum }_{i = 1}^{4} {f}_{compadi} - {f}_{weight} + Δ f \qquad ( Formula 4 )$$

where fcorri represents the posture control propulsion force of each propulsion unit 12, fcompadi represents the self-weight compensation propulsion force of each propulsion unit 12, and fweight represents the self-weight compensation target. In addition, Δf represents a disturbance force.

Further, from the relationship of the moment around the center of gravity, the following Formula 5 holds.

$$[ Math . 4 ]$$

$$\begin{matrix}{M}_{all} = {\sum }_{i = 1}^{4} {r}_{Ri} \times {f}_{Ri} + {\sum }_{i = 1}^{4} {r}_{ri} \times {f}_{rVi} + {\sum }_{i = 1}^{4} {r}_{ri} \times {f}_{corri} + Δ M \\ = {\sum }_{i = 1}^{4} {r}_{Ri} \times {f}_{Ri} + {\sum }_{i = 1}^{4} {r}_{vi} \times {f}_{vi} + {\sum }_{i = 1}^{4} {r}_{ri} \times {f}_{corri} + Δ M\end{matrix} \qquad ( Formula 5 )$$

where ΔM represents a disturbance moment.

As can be seen from Formula 1 through Formula 5, the assist control for generating the assistive support force based on Formula 1 through Formula 3 can be performed by adding the posture feedback control and the self-weight compensation control, and hence, in the mobile robot 10, it is possible to select, according to the purpose of each control, the implementation of the control easily. However, it should be noted that in the case where the posture feedback control or the self-weight compensation control is added to the assist control, the actual virtual support position P1, the actual assistive support force F1, the actual support generation position P2, and the actual resultant force F2 will change.

### OTHER EMBODIMENTS

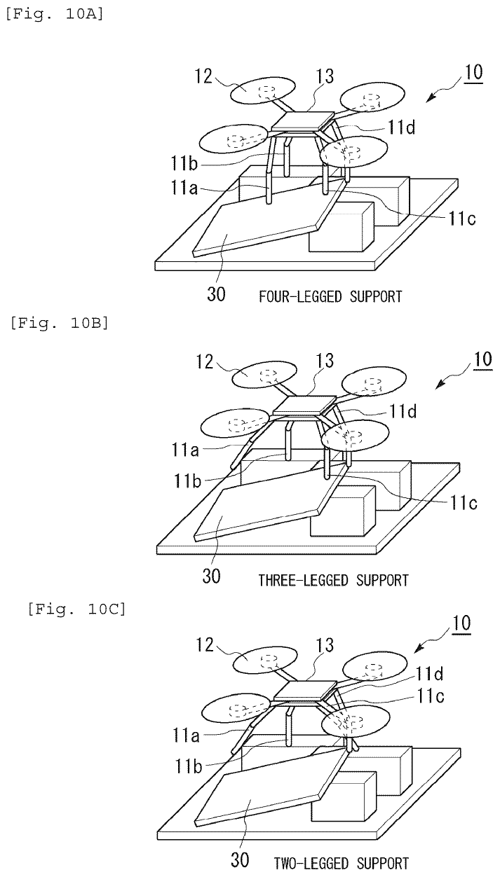

First, a first form of the support state by the leg portions 11 during the walking motion of the mobile robot 10 will be described based on FIG. 10. Note that in FIG. 10, the motion of walking is performed on a contact surface that is not a flat surface but is in a so-called uneven ground state. The upper part (a) of FIG. 10 discloses a state in which the main body portion 13 of the mobile robot 10 is supported by using all of the four leg portions 11. In addition, the middle part (b) discloses a state in which three leg portions 11 among the four leg portions 11 are used to support the main body portion 13 of the mobile robot 10, and specifically, the leg portion 11a is separated from the contact surface, and the main body portion 13 is supported by the other leg portions 11b, 11c, 11d. Also, the lower part (c) discloses a state in which the main body portion 13 of the mobile robot 10 is supported by using two leg portions 11 among the four leg portions 11, and specifically, the leg portions 11a, 11c are separated from the contact surface, and the main body portion 13 is supported by the other leg portions 11b, 11d.

The state of being supported by the four leg portions 11 is the most stable state, but in the case where the contact surface is in the uneven ground state as in the present form, there is a possibility that the target pressure position PP deviates from the actual support region SS due to tilting or inclination of the mobile robot 10 or the like. In such a case, the assist control for the walking control by the second controller 200 described above can be executed. In this regard, the same applies to the case of being supported by three leg portions 11.

Here, as illustrated in FIG. 10 (c), in the case of being supported by two leg portions 11, the actual support region SS formed by the leg portions 11b, 11d in contact with the contact surface is a straight line region connecting their respective contact points. In such a case, when the target pressure position PP is on the straight line, it is determined that the target pressure position PP is inside the actual support region SS, and when the target pressure position PP deviates from the straight line, it is determined that the target pressure position PP is not inside the actual support region SS. Then, in the latter case, the assist control for the walking control by the second controller 200 described above may be executed.

The walking motion of the mobile robot 10 does not necessarily have to be walking using the four leg portions 11. For example, depending on the shape and slope of the contact surface, two leg portions 11a, 11c of the four leg portions 11 may be always kept separated from the contact surface, and the remaining two leg portions 11b, 11d may be used for walking. That is, the walking motion should be performed using the number of leg portions most suitable for the condition of the contact surface, and if the mobile robot 10 cannot be stably supported by those leg portions, the assist control for the walking control by the second controller 200 described above should be performed.

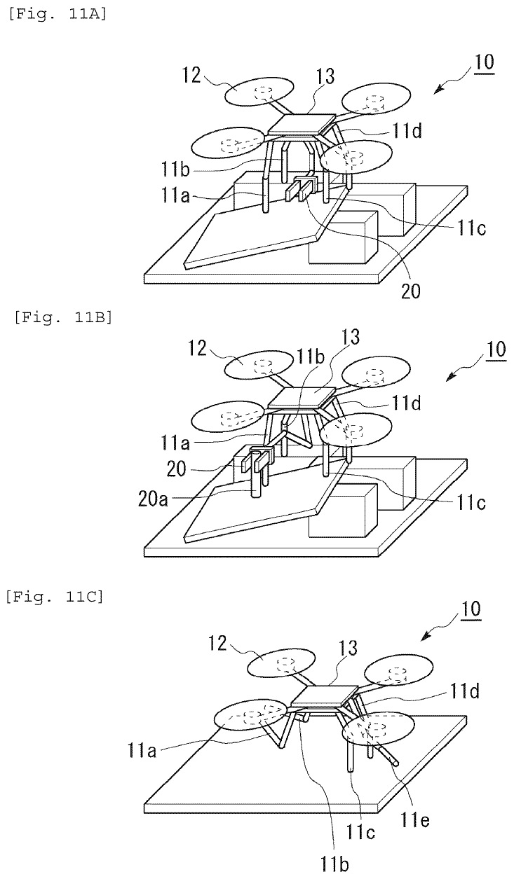

Next, a second form of the support state by the leg portions 11 at the time of the walking motion of the mobile robot 10 will be described based on FIG. 11. The upper part (a) of FIG. 11 discloses a state in which the main body portion 13 of the mobile robot 10 is supported by using all of the four legs 11 as well as an end effector 20, which originally has a holding or grasping mechanism for holding or grasping an object. The number of contact points for supporting the main body portion 13 is increased by the contact between the end effector 20 and the contact surface, so that the actual support region SS can be enlarged. This increases the chance that the target pressure position PP will be included in the actual support area SS, thereby achieving a more stable walking motion. Even in such a case, if the target pressure position PP deviates from the actual support region SS, the assist control for the walking control by the second controller 200 described above can be executed.

In addition, the middle part (b) discloses a state in which the main body portion 13 of the mobile robot 10 is supported by using an object 20a grasped or held by the end effector 20 in addition to all of the four leg portions 11. In this case, an actual support region SS is formed by a contact point between the object 20a held by the end effector 20 and the contact surface. For example, in a case where the mobile robot 10 walks while carrying the object 20a, a stable walking motion may be achieved by making use of the object. Even in such a case, if the target pressure position PP deviates from the actual support region SS, the assist control for the walking control by the second controller 200 described above can be executed.

Moreover, the lower part (c) discloses a state in which the main body portion 13 of the mobile robot 10 is supported by, in addition to two leg portions 11c, 11d among the four leg portions 11, using an auxiliary support portion 11e, which is not directly used for the walking motion unlike the leg portions 11 but is configured to be capable of supporting the main body portion 13 during the walking motion. The auxiliary support portion 11e is a structure that does not have a joint and an actuator for driving the joint as in the leg portions 11, but is configured to be capable of maintaining contact with the contact surface by applying a certain degree of load to the contact surface. In this case, too, an actual support region SS will be formed by a contact point between the auxiliary support portion 11e and the contact surface. The support force of the auxiliary support portion 11e can, in some cases, be weaker than the support force by the leg portions 11, but for example, when comparing the case of walking with the two leg portions 11c, 11d and the case of walking by adding the auxiliary support portion 11e thereto, the actual support region SS can be enlarged in the latter case, thereby realizing a stable walking motion. Even in such a case, if the target pressure position PP deviates from the actual support region SS, the assist control for the walking control by the second controller 200 described above can be executed.

### REFERENCE SIGNS LIST

10 . . . mobile robot; 11, 11a, 11b, 11c, 11d . . . leg portions; 11e . . . auxiliary support portion; 12, 12a, 12b, 12c, 12d . . . propulsion units; 13 . . . main body portion; 14 . . . bridge member; 15 . . . flight sensor; 16 . . . contact sensors; 17 . . . battery; 20 . . . end effector; 20a . . . object, 100 . . . first controller; 200 . . . second controller; FL . . . contact surface; PP . . . target pressure position; SS . . . actual support region; P1 . . . virtual support position; P2 . . . support generation position; F1 . . . assistive support force; F2 . . . resultant force.

1. A mobile robot comprising:
a main body portion having a plurality of propulsion units each configured to generate a propulsion force by driving of a rotary wing;
a plurality of support portions provided on the main body portion and configured to come into contact with a predetermined contact surface to be capable of supporting at least a part of the main body portion;
a first controller configured to perform movement control for moving the main body portion on the predetermined contact surface by the plurality of support portions while supporting the main body portion by the plurality of support portions; and
a second controller configured to perform assist control for the movement control by the first controller by using a part or all of the plurality of propulsion units;
wherein in the assist control, when a target pressure position related to the transition of a center of gravity of the main body portion in the movement control is not inside an actual support region in which the main body portion is actually supported by predetermined support portions that are in contact with the predetermined contact surface among the plurality of support portions, the second controller drives a part or all of the plurality of propulsion units to generate in the outside of the actual support region an assistive support force that assists a shortage of a support force required for the movement control.

2. The mobile robot according to claim 1, wherein the second controller comprises:
an acquisition module configured to acquire the target pressure position;
a setting module configured to set a support generation position at which the support force by the predetermined support portions is generated inside the actual support region; and
an execution module configured to identify, based on the target pressure position and the support generation position, a virtual support position on the predetermined contact surface outside the actual support region, with which the predetermined support portions are not in contact, calculate the assistive support force at the virtual support position, and drive a part or all of the plurality of propulsion units to generate the assistive support force.

3. The mobile robot according to claim 2, wherein the virtual support position is identified by the execution module so that the target pressure position is included in an enlarged support region that is defined by the actual support region and the virtual support position.

4. The mobile robot according to claim 3, wherein the virtual support position is on the opposite side of the support generation position across the target pressure position, and the virtual support position, the target pressure position, and the support generation position are arranged on a straight line.

5. The mobile robot according to claim 4, wherein the virtual support position is identified as a position farthest from the target pressure position within a range allowed to be set based on an arrangement of the plurality of propulsion units.

6. The mobile robot according to claim 1,
in a case where the number of predetermined support portions in contact with the predetermined contact surface among the plurality of support portions is three or more, the actual support region is a polygonal region formed by connecting contact points between each of the predetermined support portions and the predetermined contact surface; and
in a case where the number of predetermined support portions in contact with the predetermined contact surface among the plurality of support portions is two, the actual support region is a straight line region formed by connecting contact points between each of the two predetermined support portions and the predetermined contact surface.

7. The mobile robot according to claim 1, wherein the plurality of propulsion units are arranged in line symmetry or point symmetry with respect to the main body portion when viewed from the gravity direction of the main body portion.

8. The mobile robot according to claim 1, wherein the plurality of support portions are a plurality of leg portions attached to the main body portion so as to be capable of supporting the weight of the main body portion.

9. The mobile robot according to claim 8, wherein the plurality of support portions further comprise a holding portion capable of holding an object, or the object held by the holding portion so as to be capable of coming into contact with the predetermined contact surface.
